(19) United States
(12) Patent Application Publication
(10) Pub. No.: US 2018/0219312 A1
(43) Pub. Date: Aug. 2, 2018

(54) WITHDRAWABLE-CARD-TRAY POSITION-FIXING STRUCTURE FOR ELECTRONIC DEVICE

(71) Applicant: Molex, LLC, Lisle, IL (US)

(72) Inventors: Sung Hyuk JOO, Ansan (KR); In Chull YANG, Ansan (KR)

(73) Assignee: Molex, LLC, Lisle, IL (US)

(21) Appl. No.: 15/500,439

(22) PCT Filed: Aug. 13, 2015
(86) PCT No.: PCT/KR15/08516

§ 371 Date: Jan. 30, 2017

(30) Foreign Application Priority Data
Aug. 14, 2014 (KR) 10-2014-0106277

(51) Int. Cl. H01R 12/70; H01R 12/71

(52) U.S. Cl. CPC H01R 12/7064; H01R 12/71

(57) ABSTRACT

A withdrawable-card-tray position-fixing structure for an electronic device, which is adapted to allow a tray having a card mounted thereon to be stably positioned within the device, is provided. The structure has a tray and a tray position-fixing member. The tray has a mounting hole formed in a card-mounting section thereof where the card is mounted. The tray position-fixing member is formed from a resilient material that is itself resilient while having a large surface coefficient of friction. The tray position-fixing member is mounted either on the tray itself, in a tray insertion pathway or both, and into which the tray is inserted by being press fitted therein. The structure is adapted to achieve an improved force of friction between the tray position-fixing member and a counterpart member which comes into contact therewith, and achieves an improved tray position-fixing capability via the press fitting of the tray.

### RELATED APPLICATIONS

This application is a national stage application of International Application No. PCT/KR2015/008516, filed Aug. 13, 2015, which claims priority to Korean Patent Application No. 10-2014-0106277, filed Aug. 14, 2014, both of which are incorporated herein by reference in their entireties.

### TECHNICAL FIELD

The present disclosure relates to a position-fixing structure for a withdrawable card tray for an electronic device, the structure being adapted to allow a tray having a card mounted thereon to be inserted into and withdrawn from the electronic device; and more specifically, the disclosure relates to a withdrawable-card-tray position-fixing structure for an electronic device, the structure being adapted to allow a tray having a card mounted thereon to be stably positioned within the electronic device.

### BACKGROUND ART

With regard to electronic devices such as smartphones in which various cards (memory cards or SIM cards) are mounted, cards have been developed that for convenience of use are loaded on a tray for insertion.

One example of prior art in which a card is loaded onto a tray for mounting in a smartphone is U.S. Pat. No. 7,865,210 B2 (hereinafter “the Reference”).

According to the Reference, retention bars placed respectively on the left and right sides of the tray insertion path contact the sloped surfaces formed on the sides of the tray, pulling the tray in the insertion direction, so that the tray exterior is flush with the smartphone exterior.

The thus-configured Reference has the drawback that the tray cannot be freely positioned, because the retention bars always pull the tray in the insertion direction, so that the tray's position is always consistent.

Reference 1: U.S. Pat. No. 7,865,210 (2011 Jan. 4)

Reference 2: U.S. Pat. No. 8,145,261 (2012 Mar. 27)

### SUMMARY

The purpose of this disclosure, which has been devised in order to address the above-described problems of the prior art, is to provide a position-fixing structure for a withdrawable card tray for an electronic device, which can fix the tray in any given position.

Another purpose of this disclosure is to provide a position-fixing structure for a withdrawable card tray for an electronic device that can prevent an inserted card tray from slipping out of its fixed position or protruding outside the electronic device.

The withdrawable-card-tray position-fixing structure for an electronic device of the present disclosure pertains to an electronic device so constituted that the card is mounted on the tray so as to be inserted therein and withdrawn therefrom, the disclosure comprising: a tray having a mounting hole or mounting recess formed in a card-mounting section thereof where the card is mounted; and a tray position-fixing member which is formed from a resilient material that is itself resilient while having a surface with a high coefficient of friction, and which is mounted either on the tray itself or in a tray insertion pathway or both, and into which the tray is inserted by being press-fitted therein, and the disclosure is adapted so as to achieve an improved force of friction between the tray position-fixing member and a counterpart member which comes into contact therewith, and to achieve an improved tray position-fixing capability via the press-fitting of the tray.

The disclosure further comprises a card-fixing member formed of a resilient material that has a high coefficient of surface friction and is itself resilient, furnished inside a mounting recess or mounting hole so as to be securely press-fitted into said mounting recess or mounting hole; the card fixing member is furnished either surrounding the inside of the mounting recess or mounting hole, or protruding inward from the edge of the mounting recess or mounting hole.

The tray position-fixing member either furnishes an attachment projection of a resilient material that protrudes laterally toward both sides of the tray and securely attaches to the counterpart member on the tray insertion path, or is formed of a rotating roller of resilient material and is furnished rotatably on each side of the tray insertion path, securely attaching to both sides of the tray when the tray is inserted.

The tray position fixing member comprises: a resilient contact member formed of resilient material and furnished on both sides of said tray; and a resilient pressing member furnished on both sides of the tray insertion path, that presses the resilient contact member when contacted to the resilient pressing member.

The resilient pressing member is formed as a leaf spring, its front end is fixed to either side of the entrance of the tray insertion path, and its rear end is set apart from the tray insertion path and is separated from said tray insertion path, so that when the tray is inserted, the tray pressing member is pushed to the side by the tray, and then when it contacts the resilient contact member, it returns to its original state and presses against the resilient contact member.

A pressing projection that presses the resilient contact member is formed protruding inward toward the tray insertion path, and relative to the tip of the pressing projection, the sloped surface located on the entrance of the tray insertion path is at a gentler slope than the sloped surface on the opposite side.

According to the position fixing structure for a withdrawable card tray for an electronic device of this disclosure, a tray is inserted by press-fitting into a tray insertion path, using a tray position fixing member having its own resilience and formed of a resilient material having a high coefficient of surface friction, and the tray may be stably held in position using the high friction acting between the tray position fixing member and the counterpart member Accordingly, movement of tray may be prevented when the user has positioned the tray in a given position; when the tray has been fully inserted, the protrusion of the tray outside the electronic device or slippage of the tray from its fixed position may be prevented, with the tray kept flush with the device exterior.

### BRIEF DESCRIPTION OF THE DRAWINGS

FIG. 1 is a perspective view showing a smartphone using the withdrawable card tray position fixing structure for an electronic device according to Embodiment 1 of this disclosure.

FIG. 2 is a perspective view of the tray shown in FIG. 1.

FIG. 3 is a plan view of the tray shown in FIG. 2.

FIG. 4 is a plan view showing a card mounted on the tray shown in FIG. 3.

FIG. 5 is a plan view showing a tray using the withdrawable card tray position fixing structure for an electronic device according to Embodiment 2 of this disclosure.

FIG. 6 is a plan view showing a card mounted on the tray shown in FIG. 5.

FIGS. 7 and 8 are plan views showing a tray using the withdrawable card tray position fixing structure for an electronic device according to Embodiment 3 of this disclosure.

FIG. 9 is a plan view showing a tray using the withdrawable card tray position fixing structure for an electronic device according to Embodiment 4 of this disclosure.

FIG. 10 is a plan view showing the withdrawable card tray position fixing structure for an electronic device according to Embodiment 5 of this disclosure.

FIG. 11 is a plan view showing the withdrawable card tray position fixing structure for an electronic device according to Embodiment 6 of this disclosure.

FIGS. 12 and 13 are plan views showing the withdrawable card tray position fixing structure for an electronic device according to Embodiment 7 of this disclosure.

FIG. 14 is a plan view showing the withdrawable card tray position fixing structure for an electronic device according to Embodiment 8 of this disclosure.

FIG. 15 is a plan view showing the use in a card socket of the withdrawable card tray position fixing structure for an electronic device according to Embodiment 9 of this disclosure.

FIG. 16 is an enlarged view of part of FIG. 15.

### DETAILED DESCRIPTION OF THE PREFERRED EMBODIMENTS

Hereinbelow, preferred embodiments of this disclosure will be described in detail with reference to the attached drawings.

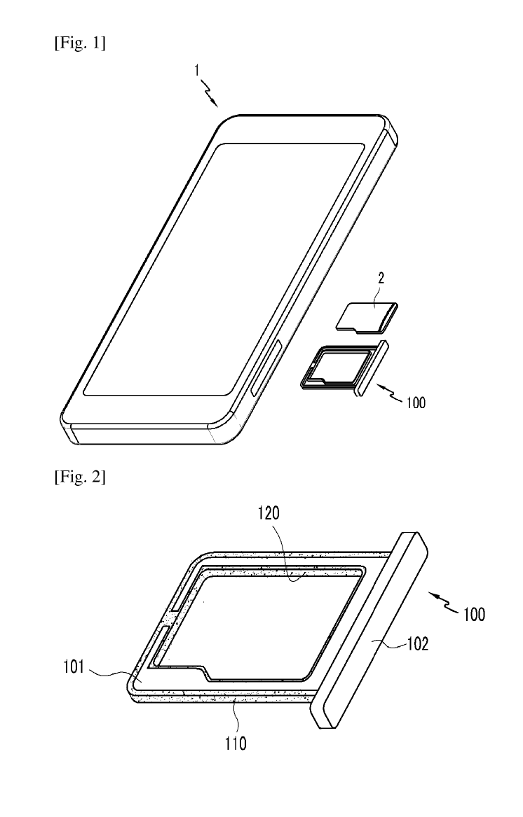

FIG. 1 is a perspective view showing a smartphone using the withdrawable card tray position fixing structure for an electronic device according to Embodiment 1 of this disclosure; FIG. 2 is a perspective view of the tray shown in FIG. 1.

On the smartphone 1 is furnished a tray 100 inserted with a card (memory card or SIM card) 2 mounted thereon. On the inside of the smartphone 1, a tray insertion path (not shown) is formed whereinto the tray 100 is slidably inserted.

The tray 100 comprises a card mounting part 101 whereon a recess or hole is formed for card insertion, and a handle 102 that is formed on the front part of the card mounting part 101 so that it can be grasped by hand and pushed or pulled. When the tray 100 is inserted into the smartphone 1, the card mounting part 101 is inserted into the tray insertion path and the handle 102 is positioned at the entrance to the tray insertion path. When the tray 100 has been fully inserted, the surface of the handle 102 is flush with the surface of the smartphone 1.

On the outside of the card mounting part 101 that makes up the tray 100, a tray position fixing member 110 is furnished that holds the position of the tray 100, and on the inside of the card mounting part 101 a card fixing member 120 is furnished for fixing the card 2 within the card mounting part 101. Both the tray position fixing member 110 and the card fixing member 120 have resilience and are made of a resilient material such as heat-resistant rubber or silicone.

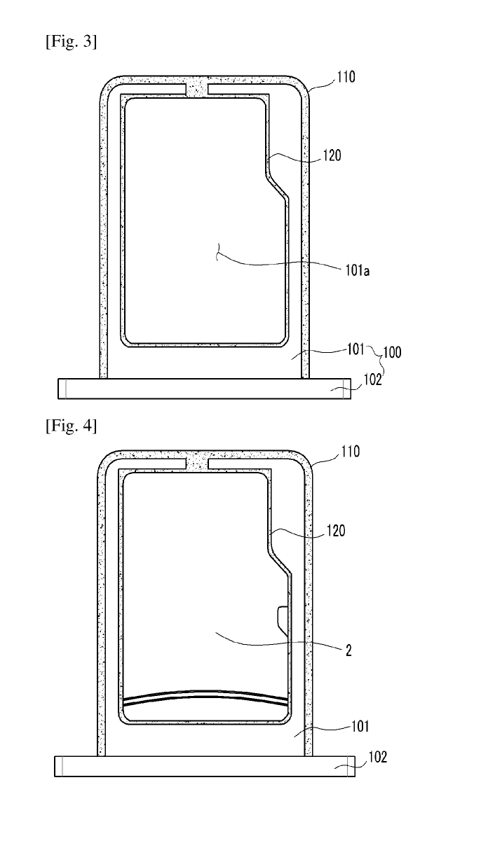

FIG. 3 is a plan view of the tray shown in FIG. 2; FIG. 4 is a plan view showing a card mounted on the tray shown in FIG. 3.

On the card mounting part 101 that makes up the tray 100, a card mounting hole 101a is formed into which a card 2 is fitted and fixed in position.

Of the four sides of the card mounting part 101, each side other than the front side has a shape that is surrounded by the tray position fixing member 110 made of resilient material. When the tray 100 has been inserted into the tray insertion path, both sides of the card mounting part 101 are slid and press-fit between the sides of the tray insertion path.

Consequently, even if the force that had been applied to the handle 102 to insert the tray 100 is released, the tray 100 is not moved by the friction between the tray position fixing member 110 and the tray insertion path, but remains stationary and fixed in position.

The inner side of the card mounting hole 101a formed on the card mounting part 101 has a shape that is surrounded by the card fixing member 120 formed of resilient material. Consequently, when the card 2 is mounted on the tray 100, the card 2 does not detach from the tray 100 even when the tray 100 is shaken or inverted, because the card 2 is firmly fixed by being press-fit into the card mounting hole 101a by the card fixing member 120.

The rear center of the card mounting part 101 is pierced toward the rear; via the pierced portion, the tray position fixing member 110 and card fixing member 120 are integrally connected.

The tray position fixing member 110 is furnished in a shape that fully surrounds both sides and the rear of the card mounting part 101, leaving out only the front part that connects the handle 102; but the disclosure is not limited thereto, and it may also be furnished in a way that surrounds only part of the sides and rear face, or may be furnished surrounding only the sides and not the rear face. The case of the card fixing member 120 may also be furnished so as to surround only a portion of the interior surface of the card mounting hole 101a.

Because the card fixing member 120 of resilient material surrounds the interior surface of the card mounting hole 101a where the card 2 is mounted, the card 2 does not directly contact the tray 100. Consequently, because there is no risk of an electrical short occurring with the card 2 even if the tray 100 is made of a metal material, there is no need to separately coat the surface of the tray 100 with a nonconductive coating.

According to the above-described configuration of a position fixing structure for a withdrawable card tray for an electronic device, when a card 2 is mounted on the tray 100 and the tray 100 is inserted into the tray insertion path of the smartphone, the tray 100 is slid by press-fitting into the tray insertion path, and there is substantial friction between the tray insertion path and the tray position fixing member 110 that surrounds the tray 100. Accordingly, after the tray 100 has been inserted to a given position, even if the force with which the tray 100 was pushed is released, the tray 100 remains stably in a stationary position and does not move. In addition, the tray 100 may be prevented from protruding or slipping outside the smartphone when the tray 100 has been fully inserted.

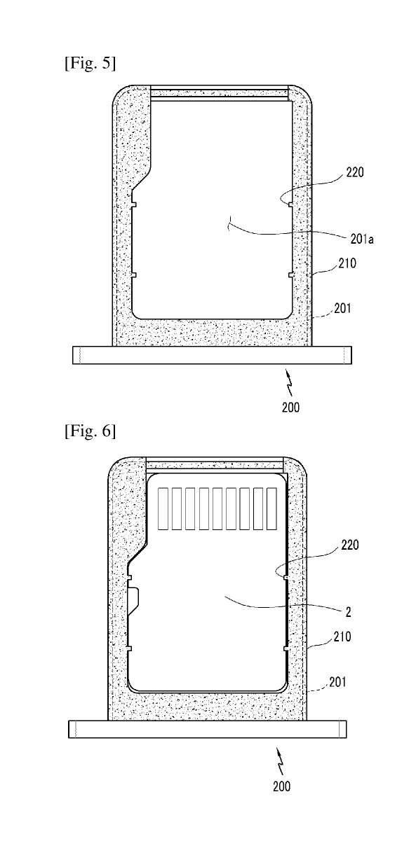

FIG. 5 is a plan view showing a tray using the withdrawable card tray position fixing structure for an electronic device according to Embodiment 2 of this disclosure; FIG. 6 is a plan view showing a card mounted on the tray shown in FIG. 5.

In this embodiment, the tray 200 is made from sheet metal, and a position fixing structure for a withdrawable card tray for an electronic device is shown wherein the card 2 is seated upside-down on the tray 200. The card 2 is mounted by the top surface of the card 2 contacting the tray 200 as seen from above, the bottom contact surface of the card 2 being exposed to the exterior.

On the card mounting part 201 that makes up the tray 200, a card mounting recess 201a is formed into which a card 2 is fitted and fixed in position.

The tray position fixing member 210 of resilient material is furnished in a form that surrounds the edge of the card mounting part 201.

On both sides of the entrance of the card mounting recess 201a, a card fixing member 220 in the form of a projection that prevents the card 2 inserted into the card mounting recess 201a is formed protruding into the interior of the card mounting recess 201a. The card fixing member 220 is formed integrally with the tray position fixing member 210 that surrounds the card mounting part 201, but it is not limited thereto, and may also be formed separately from the tray position fixing member 210.

When the card 2 is fixed in position, the card fixing member 220 partially covers both edges of the card 2, so that the card 2 is prevented from separating from the card mounting recess 201a. Because the card fixing member 220 is formed of a resilient material, the card 2 may be inserted into the card mounting recess 201a without difficulty.

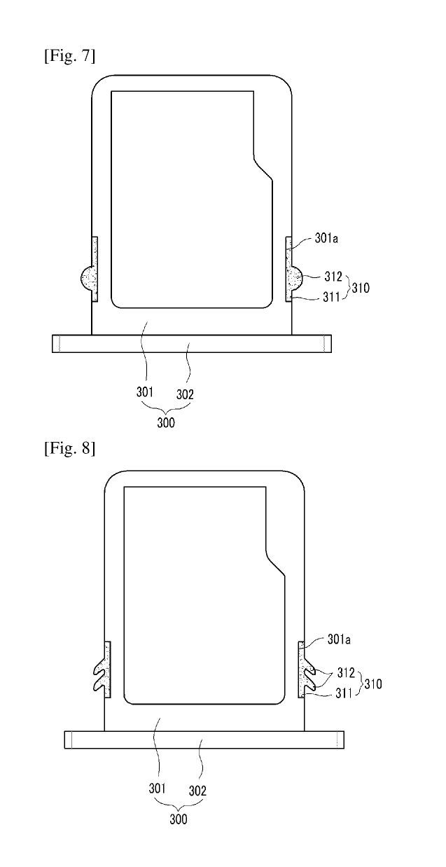

FIGS. 7 and 8 are plan views showing a tray using the withdrawable card tray position fixing structure for an electronic device according to Embodiment 3 of this disclosure.

A tray position fixing member 310 partially made of resilient material is furnished on a certain portion of both sides of the card mounting part 301 that makes up the tray 300. On both sides of the card mounting part 301, a fixing recess 301a is formed whereinto the tray position fixing member 310 is inserted.

The tray position fixing member 310 consists of a fixing part 311 that is inserted and fixed in the fixing recess 301a of the card mounting part 301, and a contact projection 312 that contacts both sides of the tray insertion path and is formed protruding toward both sides of the card mounting part 301.

The shape of the contact projection 312 may be semicircular as in FIG. 7, or it may be in the shape of diagonally downward-sloping rods as in FIG. 8. When the contact projection 312 slopes diagonally downward, it is preferable that the slope be toward the handle 302, so relatively more force is required to for withdrawing the tray 300 than for inserting it.

The tray 300 is press-fit and inserted within the tray insertion path by the contact projection 312 of the tray position fixing member 310, and substantial frictional force operates between the contact roller 312 and the tray insertion path due to the properties of the resilient material.

FIG. 9 is a plan view showing a tray using the withdrawable card tray position fixing structure for an electronic device according to Embodiment 4 of this disclosure.

A sealing member 410 is furnished on the back surface of the handle 401, made of a resilient material, in order to fix the tray 400 in position and seal the tray insertion path. When the tray 400 is fully inserted into the tray insertion path, the tray 400 is fixed in position and the tray insertion path is sealed simultaneously, as a result of the press-fitting of the sealing member 410 into the entrance of the tray insertion path as the handle 401 is inserted into the entrance of the insertion path. Here, the sealing member 410 acts as the tray position fixing member that fixes the position of the tray 400.

The front center of the card mounting part 402 is pierced; via the pierced portion, the card fixing member 420 and sealing member 410 are integrally connected.

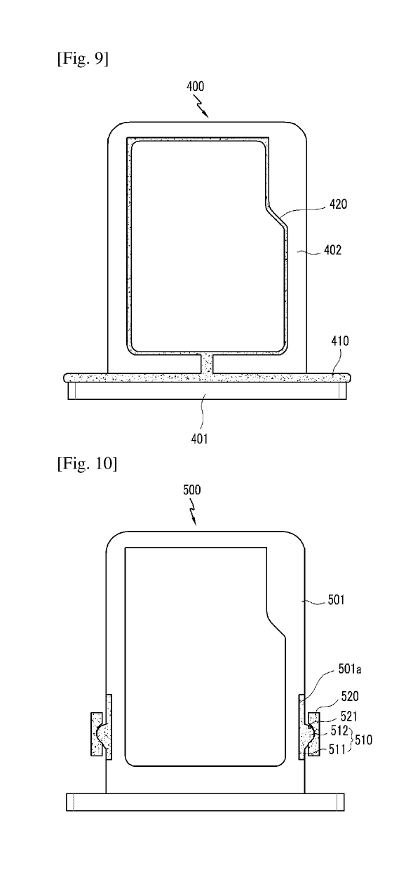

FIG. 10 is a plan view showing the withdrawable card tray position fixing structure for an electronic device according to Embodiment 5 of this disclosure.

On either side of the tray 500 and on either side of the tray insertion path are respectively furnished a tray position fixing member 510 520 for fixing the position of the tray 500.

The 1st tray position fixing member 510 furnished on both sides of the tray 500 consists of a fixing part 511 that is respectively inserted and fixed in the fixing recess 501a formed on the card mounting part 501, and a semicircular contact projection 512 that contacts the 2nd tray position fixing member 520 furnished on either side of the tray insertion path and protruding from the fixing part 511 toward both sides of the card mounting part 501.

The 2nd tray position fixing member 520 furnished on both sides of the tray insertion path has formed on one side a semicircular contact insertion recess 521 whereinto is inserted the contact projection 512 of the 1st tray position fixing member 510.

If the tray 500 is fully inserted into the tray insertion path, the position of the 1st and 2nd tray position fixing members 510 520 is set so that the contact projection 512 of the 1st tray position fixing member 510 may be inserted into the projection insertion recess 521 of the 2nd tray position fixing member 520. The radius of the contact projection 512 is formed larger than the radius of projection insertion recess 521, and the central point of the contact projection 512 is positioned above the projection insertion recess 521. Accordingly, because an effect may be obtained of the tray 500 being pulled in the insertion direction by the mating of the 1st and 2nd tray position insertion members 510 520, the position fixity of the tray 500 may be improved.

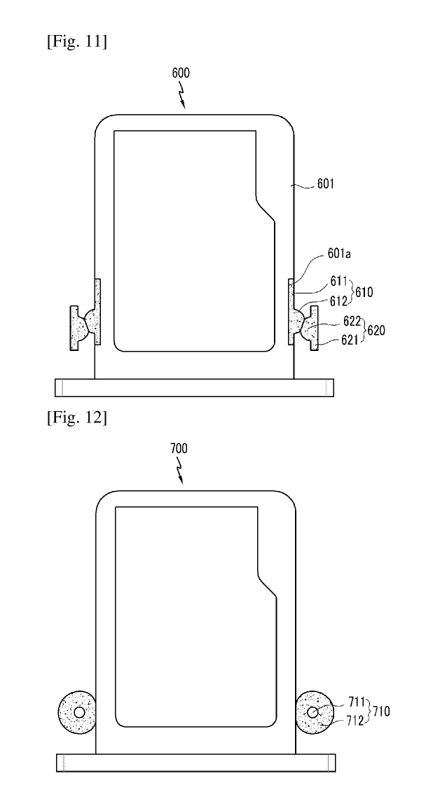

FIG. 11 is a plan view showing the withdrawable card tray position fixing structure for an electronic device according to Embodiment 6 of this disclosure.

On either side of the tray 600 and on either side of the tray insertion path are respectively furnished a tray position fixing member 610 620 for fixing the position of the tray 600.

The 1st tray position fixing member 610 furnished on both sides of the tray 600 consists of a 1st fixing part 611 that is respectively inserted and fixed in the fixing recess 601a formed on the card mounting part 601, and a semicircular 1st contact projection 612 that protrudes toward either side of the card mounting part 601 and contacts both sides of the tray insertion path.

The 2nd tray position fixing member 620 furnished on both sides of the tray insert path consists of a 2nd fixing part 621 fixed to both sides of the tray insertion path, and a semicircular 2nd contact projection 622 that protrudes from the 2nd fixing part 621 and contacts the 1st contact projection 612.

When the 1st and 2nd tray position fixing members 610 620 are mated together, the 1st contact projection 612 is positioned more obliquely in the insertion direction of the tray 600 relative to the 2nd contact projection 622. Accordingly, because an effect may be obtained of the tray 600 being pulled in the insertion direction, the position fixity of the tray 600 is improved.

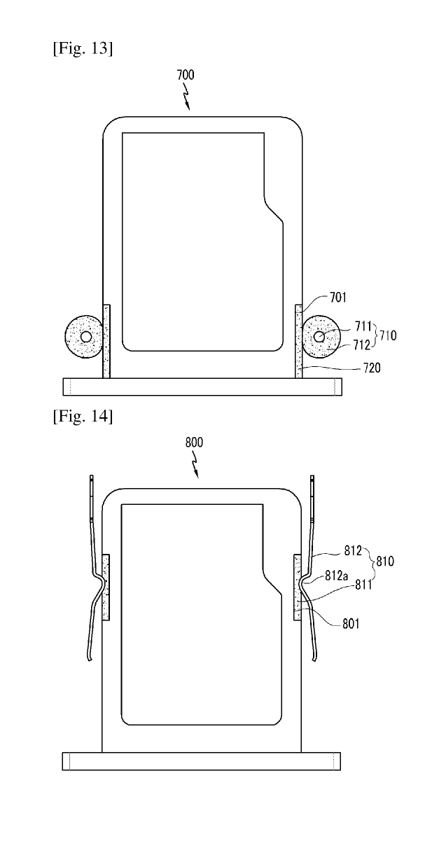

FIGS. 12 and 13 are plan views showing the withdrawable card tray position fixing structure for an electronic device according to Embodiment 7 of this disclosure.

On both sides of the tray insertion path is furnished a 1st tray position fixing member 710 in the form of a rotating roller that causes the tray 700 to be press-fit as the tray 700 is inserted. The 1st tray position fixing member 710 comprises a rotation axle 711 and a contact roller 712 that is formed of a resilient material having resilience and a high coefficient of surface friction that is fixed to the rotation axle 711 so that it rotates as it contacts the side of the tray 700.

It further comprises, on both sides of the tray 700, a 2nd tray position fixing member 720 formed of a resilient material having resilience and a high coefficient of surface friction that contacts the 1st tray position fixing member 710 when the tray 700 has been fully inserted. The 2nd tray position fixing member 720 is instead and fixed in the fixing recess 701 formed on the side of the tray 700, so as not to protrude beyond the side of the tray 700.

FIG. 12 is the form furnished only with the 1st tray position fixing member 710; FIG. 13 is the form furnished with both a 1st and 2nd tray position fixing member 710 720.

FIG. 14 is a plan view showing the withdrawable card tray position fixing structure for an electronic device according to Embodiment 8 of this disclosure.

According to this embodiment, the tray position fixing member 810 for fixing the position of the tray 800 comprises a resilient contact member 811 and a resilient pressing member 812.

The resilient contact member 811 is formed of a resilient material having resilience and a high coefficient of surface friction, and is furnished on both sides of the tray 800. On both sides of the tray 800 a fixing recess 801 is formed whereinto the resilient contact member 811 is inserted and fixed, and the resilient contact member 811 is furnished in a shape that fits flush with the surface so as not to protrude from either side of the tray 800.

The resilient pressing member 812 is furnished on both sides of the tray insertion path, and when the tray is inserted, the parts other than the resilient contact member 811 are pressed by the tray 800 so as to be pushed outward, while the portion in contact with the resilient pressing member 811 returns to its original state while pressing on the resilient contact member 811, so as to hold the tray 800 fixed in position.

The resilient pressing member 812 is formed as a leaf spring, a pressing projection 812a is formed pressing the resilient contact member 811 at a specific position.

Due to the resilient pressing member 812, the tray 800 is slid and press-fit into the tray insertion path, and a substantial frictional force acts between the resilient contact member 811 and the resilient pressing member 812.

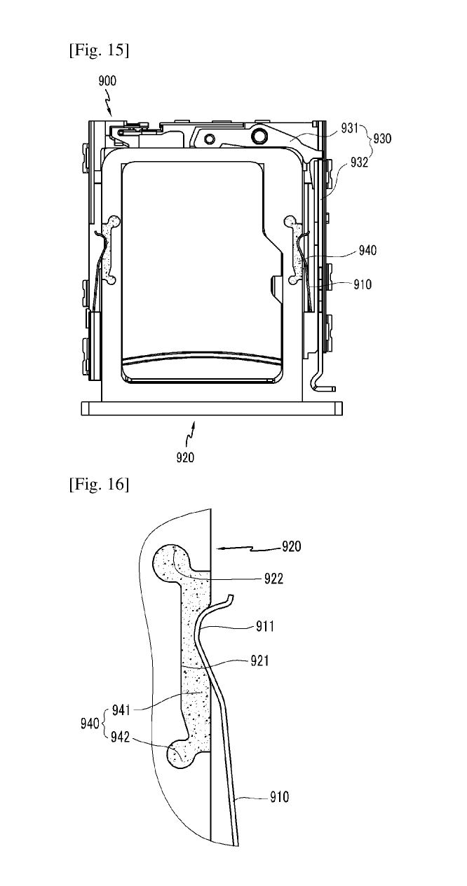

FIG. 15 is a plan view showing the use in a card socket of the withdrawable card tray position fixing structure for an electronic device according to Embodiment 9 of this disclosure; FIG. 16 is an enlarged view of part of FIG. 15.

On both sides of the insertion pathway of the card socket 900, a resilient pressing member 910 is furnished, on the card socket is furnished an ejecting structure 930 for the tray 920. On both sides of the tray 920, a resilient contact member 940 is furnished that is pressed when contacted to the resilient pressing member 910.

The resilient pressing member 910 is formed as a leaf spring; the front end is fixed to the side of the tray insertion path, and the rear end is set apart from the tray insertion path and is separated from the tray insertion path, so that when the tray 920 is inserted, it is pushed to the side by the tray 920. On the rear end of the resilient pressing member 910, a pressing projection 911 is formed protruding inward into the tray insertion path, pressing on the resilient contact member 940.

According to this configuration of the resilient pressing member 910, as the tray 920 is inserted, the pressing projection 911 is pushed outward by the side of the tray 920 until it contacts the resilient contact member 940, and when it contacts the resilient contact member 940, it returns to its original state and presses the resilient contact member 940. When the pressing projection 911 presses the resilient contact member 940, the tip portion thereof is inserted further inward than either side of the tray 920, and the tray is stably fixed in position by the frictional force between the pressing projection 911 and the resilient contact member 940.

Relative to the tip of the pressing projection 911, the sloped surface located on the entrance of the tray insertion path is at a gentler slope than the sloped surface on the opposite side, so that the tray 920 may be more easily inserted than withdrawn. In contrast, because withdrawal of the tray 920 requires relatively greater force, the stability of the position of the tray 920 may be improved.

The resilient contact member 940 is formed of a resilient material having resilience and a high coefficient of surface friction, and is furnished on both sides of the tray 920. This resilient contact member 940 comprises: a 1st fixing part 941 that is inserted into a 1st fixing recess 921 formed on both sides of the tray 920 and has a surface that is flush with both sides of the tray 920 so as to have no gap from both sides of the tray 920; and a 2nd fixing part 942 that extends from the 1st fixing part 941 and is inserted into a 2nd fixing recess 922 connected to the 1st fixing recess 921, so as to improve the fixing capability of the 1st fixing part 941. The resilient pressing member 910 contacts the surface of the 1st fixing part 941.

The ejecting structure 930 of the tray 920 comprises: a pressing part 931 that is coupled pivotably to the internal rear part of the card socket 900 via a hinge so as to press the rear end of the tray 920 forward when pivoted; and an ejecting part 932 the front end of which protrudes to the front of the card socket 900 while the rear end is furnished on both sides of the card socket 900 so as to be capable of sliding, which enables rotation of the pressing part 931 by the user pushing or pulling.

When the tray 920 has been fully inserted, then unless the ejecting part 932 is pushed or pulled, the tray 920 remains in a position-fixed state, as a result of the tray position-foxing member consisting of the resilient contact member 940 and the resilient pressing member 910.

Hereinabove, a description has been given of the position fixing structure for a withdrawable card tray for an electronic device according to this disclosure, based on preferred embodiments; however, this disclosure is not limited to specific embodiments, and a person having ordinary skill in the art of the relevant field can modify these embodiments in various ways without departing from the scope disclosed in the claims. For example, a card tray position fixing structure may also be realized by combining two or more embodiments of the various embodiments of this disclosure.

1. A withdrawable-card-tray position-fixing structure for an electronic device, for use in an electronic device so constituted that a card is mounted on a tray so as to be inserted therein and withdrawn therefrom, the structure comprising:
a tray having a mounting hole or mounting recess formed in a card-mounting section thereof where the card is mounted; and
a tray position-fixing member which is formed from a resilient material that is itself resilient while having a surface with a high coefficient of friction, and which is mounted either on said tray itself or in a tray insertion pathway or both, and into which said tray is inserted by being press-fitted therein,
adapted so as to achieve an improved force of friction between said tray position-fixing member and a counterpart member which comes into contact therewith, and to achieve an improved tray position-fixing capability via the press-fitting of said tray.

2. The structure according to claim 1, further comprising a card-fixing member formed of a resilient material that has a high coefficient of surface friction and is itself resilient, furnished inside a mounting recess or mounting hole so as to be securely press-fitted into said mounting recess or mounting hole; the card fixing member is furnished either surrounding the inside of said mounting recess or mounting hole, or protruding inward from the edge of said mounting recess or mounting hole.

3. The structure according to claim 1, wherein the tray position-fixing member either furnishes an attachment projection of a resilient material that protrudes laterally toward both sides of the tray and securely attaches to the counterpart member on the tray insertion path, or is formed of a rotating roller of resilient material and is furnished rotatably on each side of the tray insertion path, securely attaching to both sides of the tray when the tray is inserted.

4. The structure according to claim 1, wherein the tray position fixing member comprises:
a resilient contact member formed of resilient material and furnished on both sides of said tray; and
a resilient pressing member furnished on both sides of the tray insertion path, that presses the resilient contact member when contacted to the resilient pressing member.

5. The structure according to claim 4, wherein said resilient pressing member is formed as a leaf spring, its front end is fixed to either side of the entrance of the tray insertion path, and its rear end is set apart from the tray insertion path and is separated from said tray insertion path, so that when the tray is inserted, the tray pressing member is pushed to the side by the tray, and then when it contacts said resilient contact member, it returns to its original state and presses against the resilient contact member.

6. The structure according to claim 5, wherein a pressing projection that presses the resilient contact member is formed protruding inward toward the tray insertion path, and relative to the tip of the pressing projection, the sloped surface located on the entrance of the tray insertion path is at a gentler slope than the sloped surface on the opposite side.
